(19) United States
(12) Patent Application Publication
(10) Pub. No.: US 2007/0117700 A1
(43) Pub. Date: May 24, 2007

(54) Filter rod making machine

(75) Inventors: Shigenobu Kushihashi, Tokyo (JP); Masayoshi Saito, Tokyo (JP); Shinji Ishii, Tokyo (JP)

Correspondence Address: BIRCH STEWART KOLASCH & BIRCH, PO BOX 747, FALLS CHURCH, VA, 22040-0747, US

(73) Assignee: Japan Tobacco Inc.

(21) Appl. No.: 11/643,667

(22) Filed: Dec. 22, 2006

Related U.S. Application Data
(63) Continuation of application No. PCT/JP05/12395, filed on Jul. 5, 2005.

(30) Foreign Application Priority Data
Jul. 7, 2004 (JP) 2004-200880

(51) Int. Cl. B31C 13/00

(52) U.S. Cl. 493/39

(57) ABSTRACT

A filter rod making machine comprises a plurality of feed wheels (50) for feeding filter elements (f_{A}, f_{C}) at intervals; a conveyor (18) for receiving the filter elements (f_{A}, f_{C}) from the feed wheels (50) and forming an element stream in which the filter elements (f_{A}) and the filter element (f_{C}) are arranged alternately; a wrapping apparatus (62) for forming the element stream into a composite element column (C_{E}) in which the filter elements (f_{A}, f_{C}) are in close contact with each other, and then into a composite element rod (ER) by wrapping the composite element column (C_{E}) in a paper web (W); a cutting apparatus (92) for cutting the composite element rod (ER) into individual filter rods (FR); and a phase change apparatus (112) for adjusting the rotation phase of the feed wheel (50) on the basis of information on the filter rod (FR) cut.

### TECHNICAL FIELD

This invention relates to a machine for making a filter rod which is a connected series of composite filters such as dual filters, for manufacturing filter cigarettes, and particularly a machine with double tracks for making filter rods.

### BACKGROUND ART

A machine for making this type of filter rod is disclosed in Japanese Unexamined Patent Publication No. 2003-24035, for example. The making machine in this publication includes a conveyor for cylindrical filter elements, and two types of filter elements are fed onto the conveyor. The two types of filter elements are arranged alternately on the conveyor, along the direction of conveyor transportation, and transported in one direction by the conveyor. In the terminal region of the conveyor, adjacent filter elements come into close contact, thereby forming a composite element column, and the formed composite element column is fed from the conveyor to a wrapping apparatus. The wrapping apparatus wraps the composite element column in forming paper, thereby forming a composite element rod, and delivers the formed composite element rod to a cutting apparatus. The cutting apparatus cuts the composite element rod at specified intervals to form individual filter rods.

The filter rods are then fed to a machine for manufacturing filter cigarettes, namely a so-called filter attachment machine. The filter attachment machine cuts the filter rod into individual filter plugs, places a cigarette at each end of the filter plug, joins the filter plug and two cigarettes together by wrapping tip paper, thereby forming a double filter cigarette, and then cuts the double filter cigarette at the center of the filter plug, thereby forming individual filter cigarettes.

More specifically, the filter rod has an integer times the length of the filter plug, and the filter plug has twice the length of the filter contained in the filter cigarette. When the filter is a charcoal type dual filter, the filter plug comprises a plain filter element located in the center and two half charcoal-filter elements each adjacent to an end of the plain filter element. These half-elements are produced from cutting the composite element rod or the filter rod at the center of the charcoal filter element.

In order to improve the production capacity of the filter rod making machine, it is necessary to increase the traveling speed of the composite element column, or in other words, the traveling speed of the composite element rod. However, since the composite element column is formed by arranging different types of filter elements alternately on the conveyor as mentioned above, it is difficult to increase the speed of forming the composite element column, and therefore it is difficult to increase the traveling speed of the composite element rod as desired.

Meanwhile, when the above-mentioned conveyor is made as double conveyors which are arranged parallel to each other and a wrapping apparatus is provided downstream of each conveyor, two composite elements rods can be formed simultaneously. In this case, the production capacity of the making machine can be increased without increasing the speed of forming the composite element column (traveling speed of the composite element rod). In this case, it is preferable that the cutting apparatus be shared by both wrapping apparatuses, in which case the cutting apparatus cuts the composite element rods delivered from both wrapping apparatuses virtually at the same timing, thereby forming filter rods. When the cutting apparatus is shared by both wrapping apparatuses like this, an increase in complexity and size of the making machine can be avoided.

In the case of the making machine with the composite-element-rod forming track doubled as described above, if, on one of the twin forming tracks, the cutting for the filter rod, namely the cutting position at which the composite element rod is to be cut for forming a filter rod shifts, such shift cannot be compensated by adjusting the timing at which the cutting apparatus performs cutting. In other words, the adjustment of the cutting position for the filter rod on one of the two forming tracks causes a shift of the cutting position for the filter rod on the other forming track.

### DISCLOSURE OF THE INVENTION

The primary object of this invention is to provide a filter rod making machine capable of adjusting the cutting position for the filter rod without changing the timing at which the cutting apparatus cuts the composite element rod.

In order to achieve this object, a filter rod making machine according to this invention comprises

a hopper apparatus for feeding different types of filter elements, the hopper apparatus including a plurality of hoppers each storing a large number of departing rods for forming the filter elements, and a plurality of element feeders for taking the departing rods out of the hoppers, one by one, forming the filter elements by cutting the taken-out departing rods, and transporting the formed filter elements at intervals,

an element conveyor for receiving the filter elements from the element feeders of the hopper apparatus and transporting the received filter elements in one direction while continuously forming the filter elements into an element stream in which the different types of filter elements are arranged in the direction of transportation in a specified order,

a wrapping apparatus for receiving the element stream from the element conveyor, forming the received element stream into a composite element column in which the filter elements are in close contact with each other, forming the composite element column into a composite element rod by continuously wrapping the composite element column in a paper web, and delivering the formed composite element rod,

a cutting apparatus disposed downstream of the wrapping apparatus in the direction in which the composite element rod is delivered, for cutting the composite element rod into filter rods of a specified length, the filter rod including, at each end, a half-element produced from cutting the filter element of the same type in two halves,

an inspection apparatus for detecting the length of the half-element in the formed filter rod and feeding detection information, and

a change apparatus disposed on a filter element, transportation path extending from each of the hoppers up to the wrapping apparatus, for changing the transportation phase of the composite element column on the basis of the detection information from the inspection apparatus.

In the filter rod making machine described above, the inspection apparatus detects, for example the length of the half-element at the leading end of the filter rod viewed in the direction in which the composite element rod is transported. When the detected length of the half-element is smaller than a specified value, the change apparatus delays the transportation phase of the composite element column. Meanwhile, when the detected length of the half-element is greater than a specified value, the change apparatus advances the transportation phase of the composite element column. Consequently, even if the length of the half-element of the filter rod comes out of a specified range, the length of the half-element of the filter rod is automatically brought back into the specified range in the subsequent filter-rod making process, without changing the timing at which the cutting apparatus cuts the composite element rod.

Specifically, the wrapping apparatus may include

an endless garniture tape arranged to travel in the direction in which the element stream is transported and make the individual filter elements of the element stream travel with the paper web,

a tongue arranged to allow passage of the paper web and the element stream, form the composite element column by exerting a braking force on the individual filter elements of the element stream when the paper web and the element stream pass across the tongue, and allow the formed composite element column to be transported in the direction in which the garniture tape travels, and

a brake means for further exerting a braking force on each of the filter elements forming the composite element column when the filter element is just leaving the tongue, thereby producing a specified space between the filter element that has left the tongue and the succeeding filter element, in the direction in which the composite element column is transported.

In this case, preferably, the wrapping apparatus further includes a rear tongue disposed downstream of the above-mentioned tongue in the direction in which the composite element column is transported and arranged to allow passage of the paper web and the composite element column, wherein the rear tongue further exerts a braking force on the individual filter elements of the composite element column when the paper web and the composite element column pass through the rear tongue, thereby bringing the filter elements into close contact with each other so that the spaces between the individual filter elements are removed.

Meanwhile, the element feeder may include a feed wheel rotatably arranged near the element conveyor, where the feed wheel has, on a circumferential surface thereof, a plurality of feed claws arranged at equal intervals in circumferential direction of the feed wheel so that the feed claws feed the individual filter elements onto the element conveyor at intervals.

In this case, the change apparatus can include a differential gear mechanism capable of changing a rotation phase of the feed wheel, and a step motor for operating the differential gear mechanism on the basis of the detection information from the inspection apparatus.

When the rotation phase of the feed wheel is changed by the change apparatus, the above-mentioned space is increased or decreased, so that a transportation phase of the composite element column is adjusted.

The making machine may further comprise a second element conveyor similar to the above-mentioned element conveyor. In this case, the wrapping apparatus forms composite element rods from the element streams fed by the element conveyors, respectively, and the cutting apparatus is used in common for cutting both composite element rods sent out from the wrapping apparatus.

In this making machine, since two composite element rods can be formed simultaneously, the capacity to produce the filter rods improves. Further, the transportation phases of the two composite element columns, each formed into a composite element rod, are changed independently. Thus, although used in common for cutting both composite element rods, the cutting apparatus can cut each composite element rod at correct positions.

The composite element column has, for example plain elements formed of a bundle of filter fiber wrapped in forming paper, and charcoal elements formed of a bundle of filter fiber containing activated charcoal particle wrapped in forming paper. In this case, the cutting apparatus cuts the composite element rod at the center of the charcoal element so that the filter rod has, at each end, a half-element produced from the charcoal element, where the half-element and the plain element are visually identifiable although covered with the paper web.

When the filter rod has the above-described formation, the inspection apparatus can include a camera for imaging the filter rod, and an inspection circuit for detecting the length of the half-element included in the filter rod from an image of the filter rod fed from the camera, where the inspection circuit can detect a boundary between the half-element and the plain element on the basis of a difference in density between the part of the image corresponding to the half-element and the part of the image corresponding to the plain element.

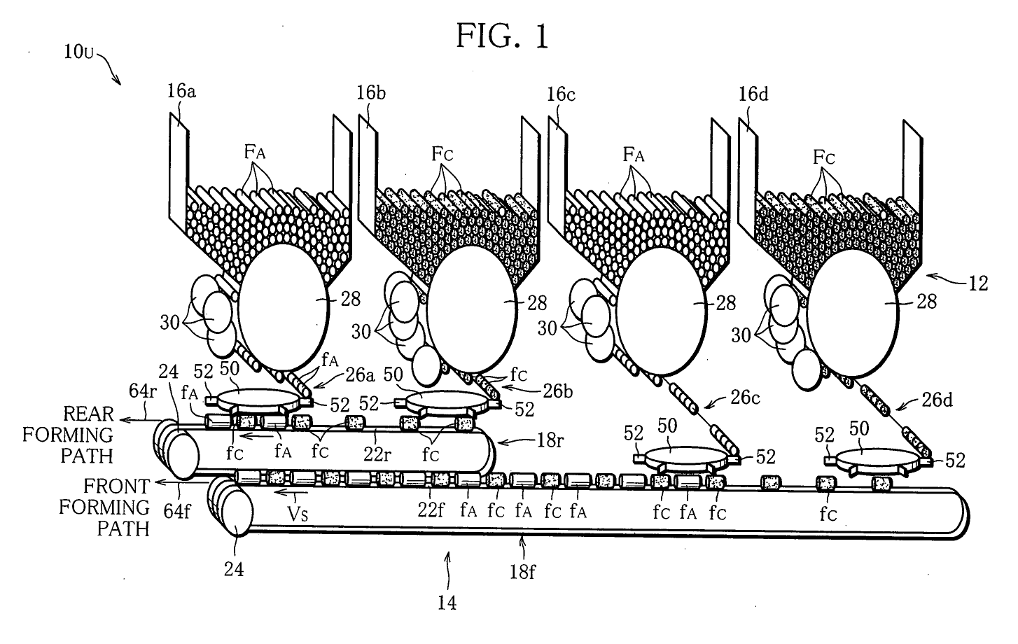

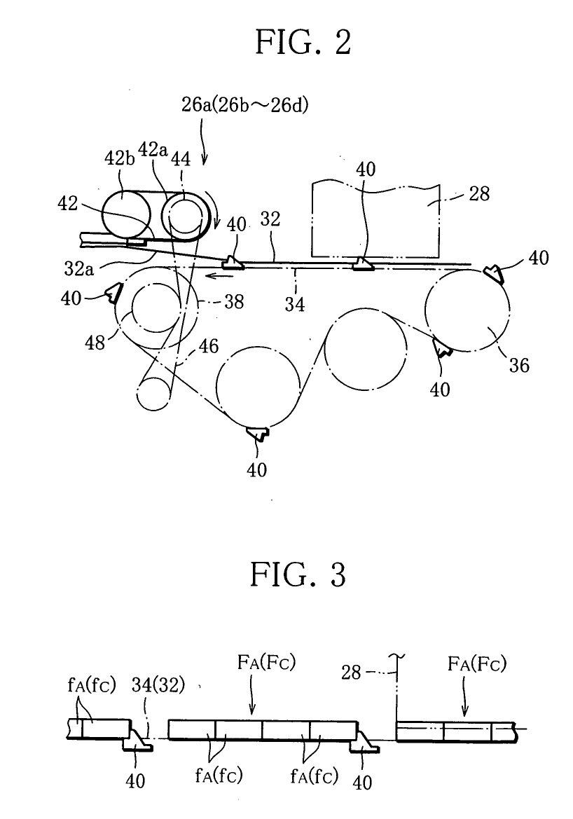

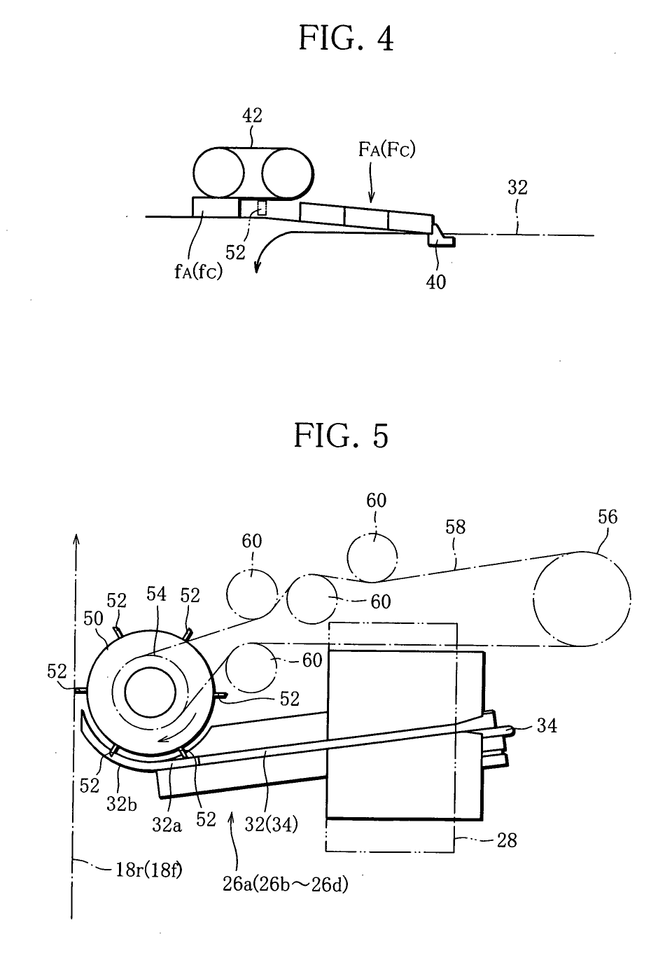

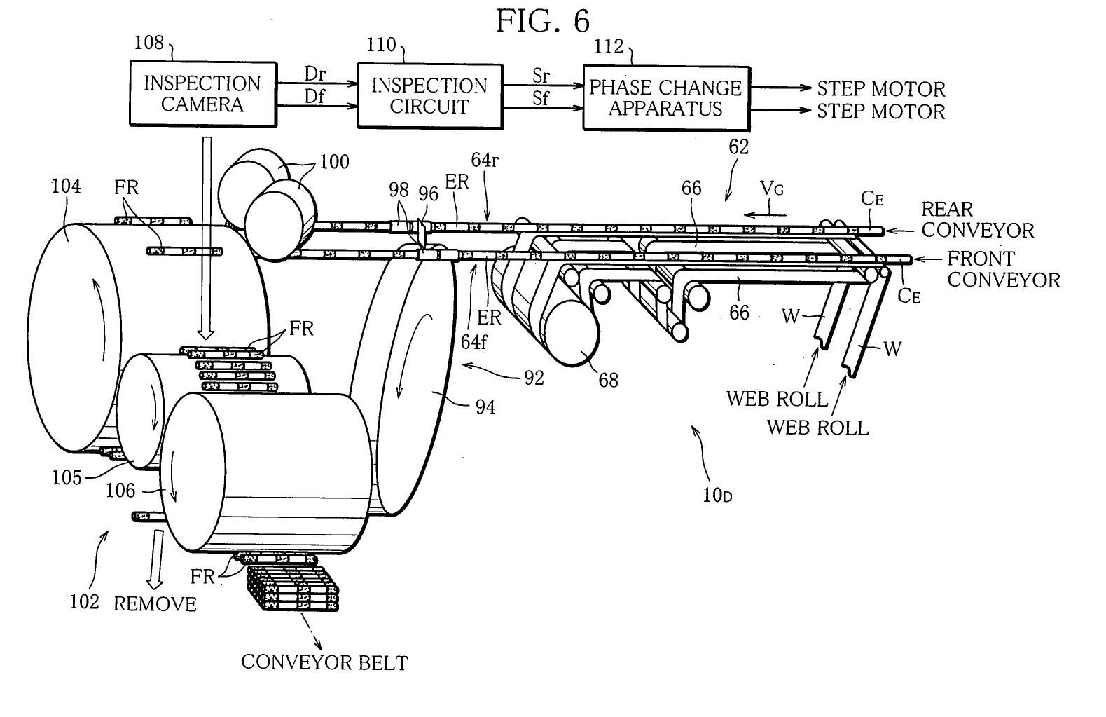

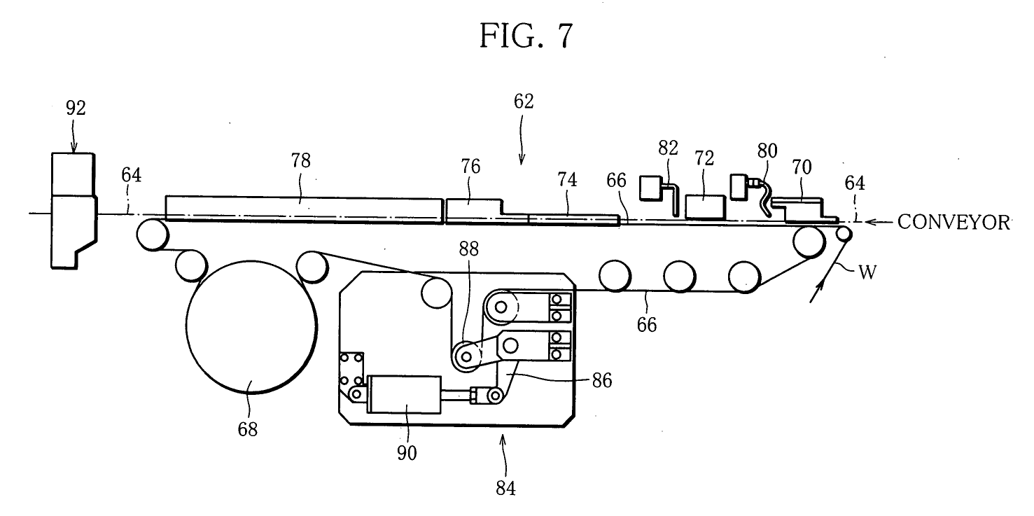

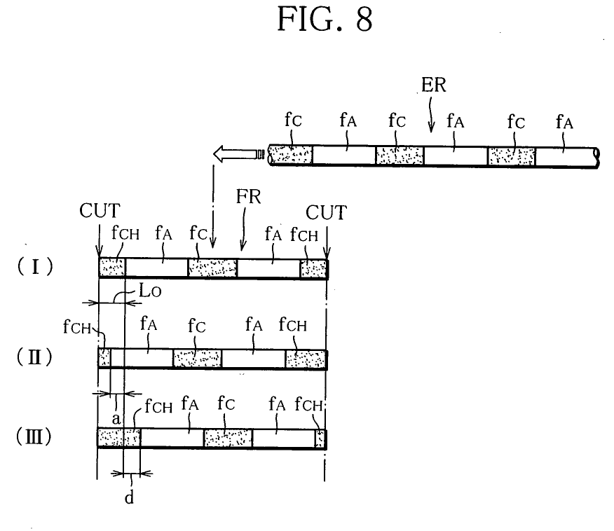

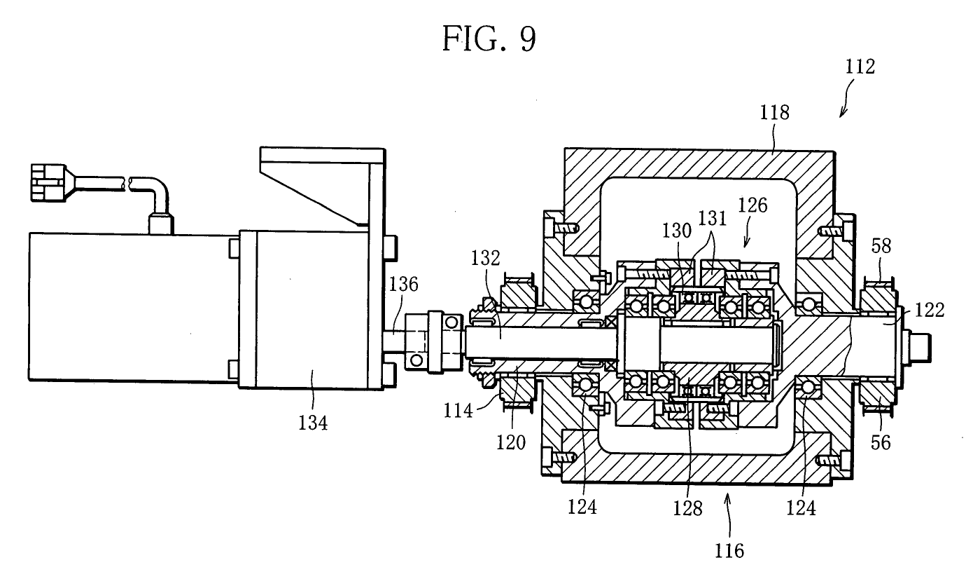

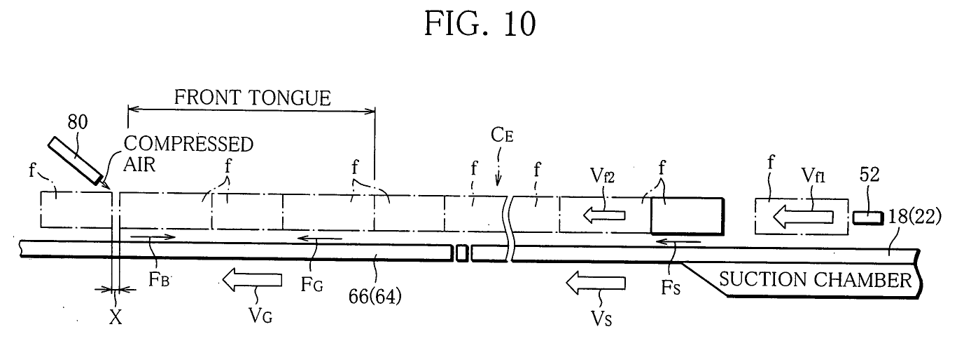

### BRIEF DESCRIPTION OF THE DRAWINGS

[FIG. 1] A diagram schematically showing an upstream section of an embodiment of a filter rod making machine.

[FIG. 2] A side view schematically showing an element feeder for filter elements.

[FIG. 3] A diagram for explaining how a departing rod is taken out of a take-out drum in the element feeder shown in FIG. 2.

[FIG. 4] A diagram for explaining how a departing rod is separated into individual filter elements.

[FIG. 5] A plan view of the element feeder shown in FIG. 2.

[FIG. 6] A diagram schematically showing a downstream section of the filter rod making machine.

[FIG. 7] A front view showing a wrapping apparatus in the downstream section.

[FIG. 8] A diagram showing filter rods obtained by cutting a composite element rod, where (I) shows a non-defective filter rod while (II) and (III) show defective filter rods, respectively.

[FIG. 9] A diagram showing a phase change apparatus partly sectioned.

[FIG. 10] A diagram for explaining how the rotation phase of a feed wheel is converted into the transportation phase of a composite element column.

### BEST MODE OF CARRYING OUT THE INVENTION

FIG. 1 shows an upstream section 10_{U} of a double-track-type filter-rod making machine.

The upstream section 10_{U} includes a hopper apparatus 12, and the hopper apparatus 12 comprises, for example four hoppers 16a to 16d. These hoppers 16 are arranged horizontally adjacent to each other and each store a large number of departing rods. Specifically, in FIG. 1, in the first and third hoppers 16a and 16c from the left are stored plain rods F_{A} as departing rods, while in the hoppers 16b, 16d, charcoal rods F_{C} different from the plain rods F_{A} are stored as departing rods.

The plain rod F_{A} includes a bundle of acetate fiber and wrapping paper which is wrapped around the fiber bundle to form it into a rod-like shape. The charcoal rod F_{C} is obtained by including activated charcoal particles in the plain rod, where the activated charcoal particles are uniformly distributed in the fiber bundle.

The upstream section 10_{U} further includes a front conveyor 18f and a rear conveyor 18r, where the conveyors 18 are arranged parallel to the series of hoppers 16a to 16d. The front conveyor 18f extends from the hopper 16a to the hopper 16d, while the rear conveyor 18r is located between the front conveyor 18b and the series of hoppers 16 and extends from the hopper 16a to the hopper 16b.

The front and rear conveyors 18f, 18r include endless suction belts 22f, 22r, respectively. The suction belts 22f, 22r are each arranged to pass around a drive roller 24. The drive rollers 24 are located at the terminal ends of the front and rear conveyors 18f, 18r, respectively. As the drive rollers 24 are rotated, the suctions belts 22f, 22r travel in the same direction at the same speed. The front and rear conveyors 18f, 18r further include suction chambers (not shown) to supply specified suction pressure to the suction belts 22f, 22r, respectively.

The hopper apparatus 12 further includes element feeders 26a, 26b for feeding plain rods F_{A} and charcoal rods F_{C} from the hoppers 16a, 16b to the rear conveyer 18r, respectively, and element feeders 26c, 26d for feeding plain rods F_{A} and charcoal rods F_{C} from the hoppers 16c, 16d to the front conveyer 18f, respectively. Also the element feeders 26a to 26d are arranged along the series of the hoppers 16a to 16d.

The element feeders 26a to 26d have virtually the same structure. Thus, only the structure of the element feeder 26a will be described below. Regarding the other element feeders 26b to 26d, the same parts and members as those of the element feeder 26a are denoted by the same reference signs in FIG. 1, and the description thereof will be omitted.

The element feeder 26a includes a take-out drum 28. The take-out drum 28 is located directly under the hopper 16a to cover the exit of the hopper 16a with its outer circumferential surface from underneath. A large number of grooves (not shown) are formed in the outer circumferential surface of the take-out drum 28, where the grooves are arranged at equal intervals in the circumferential direction of the drum 28. Each groove of the take-out drum 28 receives a plain rod F_{A} from the hopper 16a while it is within the exit of the hopper 16a, and the plain rod F_{A} received is held in the groove by suction. Thus, as the take-out drum 28 is rotated, the plain rods F_{A} are taken out of the hopper 16a one by one, each being held in a groove of the take-out drum 28, and transported on the take-out drum 28.

Further, a plurality of rotary knives 30 are provided onto the circumferential surface of the take-out drum 28. During transportation, each plain rod F_{A} passes through the rotary knives 30 successively, where the rotary knives 30 cut the plain rod F_{A} successively, so that the plain rod F_{A} is divided into a plurality of filter elements f_{A}, within the groove.

As shown in FIG. 2, directly under the take-out drum 28, a guide path 32 in the form of a groove is provided. The guide path 32 extends towards the rear conveyor 18r, and has a terminal end near the rear conveyor 18r. Under the guide path 32, an endless pusher chain 34 is disposed along the guide path 32. The pusher chain 34 is arranged to pass around a drive sprocket 36 and around a driven sprocket 38. The drive sprocket 36 is located near the beginning end of the guide path 32, while the driven sprocket 38 is located in the downstream section of the guide path 32. Thus, as clear from FIG. 2, the take-out drum 28 is arranged between the drive sprocket 36 and the driven sprocket 38. Further, two pulleys are arranged under the guide path 32. These pulleys guide the traveling of the pusher chain 34, and one of these pulleys functions as a tension pulley to impart a specified tension to the pusher chain 34. As the drive sprocket 36 is rotated, the pusher chain 34 travels along the guide path 32 in the upper portion of the chain 34.

The pusher chain 34 has a plurality of pushers 40. The pushers 40 have a claw-like shape and arranged on the pusher chain 34 at specified lengthwise intervals. While the pusher chain 34 is traveling, each pusher 40 periodically passes through the guide path 32. For this, the guide path 32 has a slit (not shown) in the bottom thereof to allow the pushers 40 to pass.

The grooves of the take-out drum 28 successively arrive directly above the guide path 32, where the pushers 40 of the pusher chain 33 each pass through the groove that has arrived directly above the guide path. Thus, as shown in FIG. 3, when plain rods F_{A} are received in the grooves of the take-out drum 28, each pusher 40 pushes a plain rod F_{A} out of a groove of the take-out drum 28, and the plain rod F_{A} pushed out is received on the guide path 32 and transported along the guide path 32 by being pushed by the pusher 40.

Immediately before the pusher 40 pushes the plain rod F_{A} out of the take-out drum 28, the suction for holding the plain rod F_{A} within the groove is removed, so that the plain rod F_{A} is smoothly pushed out of the take-out drum 28 by the pusher 40.

As clear from FIG. 2, the guide path 32 includes an upslope ramp 32a, and the upslope ramp 32a is located above the driven sprocket 38. Thus, the plain rod FA transported along the guide path 32 gets on the upslope ramp 32a by being pushed by the pusher 40, and then the pusher 40 goes below the upslope ramp 32a, or in other words, the guide path 32. Then, when the next pusher 40 pushes the succeeding plain rod F_{A} onto the upslope ramp 32a, the succeeding plain rod FA butts against the preceding plain rod F_{A} already on the upslope ramp 32a and pushes the preceding plain rod F_{A} onward. Thus, the preceding plain rod F_{A} moves forward up the upslope ramp 32a by being pushed by the succeeding plain rod F_{A}.

Meanwhile, above the guide path 32, an endless acceleration belt 42 is provided. The acceleration belt 42 is arranged such that the plain rod F_{A} can be sandwiched between the acceleration belt 42 and the upslope ramp 32a. The traveling speed of the acceleration belt 42 is higher than the traveling speed of the pusher chain 34, and as mentioned above, the plain rod F_{A} pushed out of the take-out drum 28 is already divided into individual filter elements f_{A}. Therefore, when the plain rod F_{A} moves forward up the upslope ramp 32 and the leading filter element f_{A} of the plain rod F_{A} becomes sandwiched between the acceleration belt 42 and the upslope ramp 32a, the foremost filter element f_{A} is accelerated by the acceleration belt 42 and separated from the succeeding filter elements f_{A} as shown in FIG. 4. Thus, the filter elements f_{A} of the plain rod F_{A} which has passed through the acceleration belt 42 are separated individually with a specified interval between.

As clear from FIG. 2, the acceleration belt 42 is arranged to pass around the pulleys 42a, 42b, and a toothed pulley 44 is mounted on the shaft of the pulley 42a. Meanwhile, a toothed pulley 48 is mounted on the shaft of the driven sprocket 38, where the toothed pulleys 44 and 48 are connected by a toothed belt 46. Thus, when the pusher chain 34 is caused to travel, the acceleration belt 42 travels with the pusher chain 34.

As shown in FIG. 5, the guide path 32 includes a curved path 32b in the downstream portion thereof, and the curved path 32a connects the upslope ramp 32a and the rear conveyor 18r. Near the curved path 32b, a feed wheel 50 is rotatably arranged. The circumferential surface of the feed wheel 50 extends corresponding to the curved path 32b. The feed wheel 50 has a plurality of feed claws 52 on the circumferential surface thereof. The feed claws 52 project radially outward from the feed wheel 50 and arranged at equal intervals in the circumferential direction of the feed wheel 50.

Further, a toothed pulley 54 is mounted on the shaft of the feed wheel 50. Meanwhile, a toothed pulley 56 is arranged at a distance from the feed wheel 50, where the toothed pulleys 54 and 56 are connected by an endless toothed belt 58. Further, the toothed belt 58 passes around more than one guide pulley 60, where the guide pulleys 60 impart a specified tension to the toothed belt 58. When the toothed pulley 56 is rotated, the rotation of the toothed pulley 56 is transferred to the toothed pulley 54 and therefore to the feed wheel 50 by means of the toothed belt 58, so that the feed wheel 50 rotates with the toothed pulley 56.

During the rotation of the feed wheel 50, each feed claw 52 of the feed wheel 50 periodically enters the curved path 32b and moves along the curved path 32b. More specifically, as shown in FIG. 4, when a feed claw 52 enters the curved path 32b, the feed claw 52 is located between a filter element f_{A} separated from a plain rod F_{A} by the acceleration belt 42 and the succeeding filter elements f_{A}. Then, the feed claw 52 pushes out the separated filter element f_{A} to move along the curved path 32b. Thus, the individual filter elements f_{A} are fed from the curved path 32b onto the rear conveyor 18r, or in other words, onto the suction belt 22r at intervals, and sucked onto the suction belt 22r. Then, the filter elements f_{A} are transported by the suction belt 22r, being arranged in the direction of traveling of the suction belt 22r with a specified space between each other.

As clear from FIG. 1, in the same manner as the element feeder 26a, the element feeder 26b takes charcoal rods F_{C} one by one out of the hopper 16b and feeds filter elements f_{C} produced by dividing the charcoal rods F_{C} onto the rear conveyer 18r at intervals. The feed position at which the filter element f_{C} is fed from the element feeder 26b onto the rear conveyor 18r is set upstream of the feed position at which the filter element f_{A} is fed from the element feeder 26a onto the rear conveyor 18r, and the element feeder 26a feeds a filter element f_{A} onto the rear conveyor 18r so that the filter element f_{A} are distributed between filter elements f_{C}. Thus, the filter elements f_{A} and f_{C} are transported, arranged in the direction of traveling of the rear conveyor 18r alternately and forming an element stream on the rear conveyor 18r.

Meanwhile, the element feeders 26c, 26d feed filter elements f_{A}, f_{C} onto the front conveyer 18f, respectively, and the filter elements f_{A}, f_{C} form, on the front conveyor 18f, an element stream similar to the element stream on the rear conveyor 18r.

The respective terminal ends of the front and rear conveyors 18f, 18r are connected to a downstream section 10_{D} of the making machine.

The downstream section 10_{D} includes front and rear forming paths 64f, 64r extending from the terminal ends of the front and rear conveyors 18f, 18r, respectively. Each forming path 64 is aligned with the corresponding conveyor 18 and can receive the element stream from the corresponding conveyor 18.

Near the beginning ends of the forming paths 64, a wrapping apparatus 62 is provided. The wrapping apparatus 62 is schematically shown in FIG. 6. As the element streams are transported along the forming paths 64, respectively, the wrapping apparatus 62 forms each element stream into a composite element rod.

In order to form the composite element rods, the wrapping apparatus 62 includes forming structures provided for the front and rear forming paths 64f, 64r, respectively. Since both forming structures are similar, only one of them will be described below.

The forming structure includes a forming bed (not shown), and the forming bed extends along the forming path 64. The forming bed has a forming groove (not shown) on the forming path 64, and the forming groove guides the traveling of an endless garniture tape 66. As clear from FIG. 6, the garniture tape 66 is arranged to pass around a drive drum 68, and the drive drum 68 is shared by both forming paths 64f, 64r.

As the drive drum 68 is rotated, the garniture tape 66 travels in the forming groove, where the direction of this traveling is the same as the direction of the traveling of the corresponding conveyor 18. The traveling speed V_{G} of the garniture tape 66 is, however, lower than the traveling speed V_{S} of the conveyor 18, or in other words, the suction belt 22, and between the speeds V_{S}, V_{G}, there is, for example the relation
V_{S}=1.4×V_{G}.

A paper web W is fed onto the garniture tape 66. The paper web W is unwound from a web roll (not shown). When the element stream is fed onto the forming path 64 from the corresponding conveyor 18, the filter elements f_{A}, f_{C} forming the element stream transfer onto the paper web W, and then, they are caused to travel with the paper web W by the garniture tape 66.

More specifically, the forming structure includes a ranging path (not shown) which connects the forming groove in the forming bed and the conveyor 18, and the element stream is fed from the conveyor 18 onto the paper web W via the ranging path.

Since the traveling speed V_{G} of the garniture tape 66, or in other word, the paper web W is lower than the traveling speed V_{S} of the conveyor 18 and the ranging path extends between the forming bed and the conveyor 18, the filter elements f_{A}, f_{C} in the element stream chain-collide on the ranging path and form a composite element column C_{E} in which the filter elements f_{A}, f_{C} are arranged alternately, in close contact with each other. Such composite element column C_{E} extends from the ranging path up to the terminal end of the conveyor 18. Thus, the composite element column C_{E} is continuously fed onto the paper web W.

In the process of the paper web W being fed onto the garniture tape 66, a glue is applied onto the paper web W by an applicator (not shown) to describe a rail-like pattern in the widthwise center of the paper web W. When the composite element column C_{E} is fed onto the paper web W, the rail-like glue on the paper web W sticks the composite element column C_{E} and the paper web W together, so that the composite element column C_{E} travels with the paper web W.

After this, the composite element column C_{E} is continuously wrapped in the paper web W and formed into a composite element rod ER, and the composite element rod ER is delivered from the wrapping apparatus 62. It is to be noted that in FIG. 6, the composite element rod ER is shown with the paper web W removed, namely in the same manner as the composite element column C_{E}.

In order to form the composite element rod ER, the forming structure includes, as shown in FIG. 7, a front tongue 70, a rear tongue 72, a short holder 74, a long holder 76 and a water-cooling-type cooler 78. These are arranged in this order from an upstream end of the forming path 64. The forming structure further includes an air blow nozzles 80, 82. The air blow nozzle 80 is located between the front tongue 70 and the rear tongue 72, while the air blow nozzle 82 is located between the rear tongue 72 and the short holder 74. The air blow nozzle 82 is not indispensable.

The front tongue 70 and the rear tongue 72 each cooperate with the forming groove in the forming bed to form a tunnel for the composite element column C_{E}. While passing through the tongues 70, 72, the paper web W is bent into a U-shaped cross section by the forming groove to cover the lower half of the composite element rod C_{E}.

The air blow nozzle 80 jets out compressed air toward the downstream end of the front tongue 70. The compressed air hits the part of the composite element column C_{E} that has come out of the front tongue 70 and exerts a specified braking force on the composite element column C_{E}. More specifically, at this time, the rail-like glue has not completely stuck the composite element column C_{E} and the paper web W yet, so that the composite element column C_{E} is allowed to shift relative to the paper web W, in the direction of traveling of the paper web W.

Between the front tongue 70 and the rear tongue 72, the braking force exerted on the composite element column C_{E} determines the positions of the filter elements f_{A}, f_{C} relative to the paper web W, or in other words, the phase of the composite element rod C_{E}, which will be described later.

After passing through the rear tongue 72, the composite element rod C_{E} further receives a braking force exerted by compressed air from the air blow nozzle 82 as necessary, and then passes through the short holder 74 and the long holder 76 successively, with the paper web W.

The short holder 74 and the long holder 76 each include a heater (not shown) and function in the same way as the corresponding short and long holders of a cigarette making machine. Specifically, the short holder 74 and long holder 76 bend the opposite side parts of the paper web W around the upper half of the composite element column C_{E}, successively, so that the opposite side edges of the paper web W overlap each other on the composite element column C_{E}. The opposite side edges of the paper web W are stuck together with a lapping glue. At this time, the composite element column C_{E} is completely wrapped in the paper web W, thereby forming a composite element rod ER. The composite element rod ER formed is delivered from the long holder 76 along the forming path 64.

To apply the lapping glue on the paper web W, an application nozzle (not shown) is disposed near the short holder 74. While a side part of the paper web W is bent by the short holder 74, the application nozzle continuously applies the lapping glue onto the other side edge of the paper web W.

The composite element rod ER delivered from the long holder 76 passes through the cooler 78. The cooler 78 cools the composite element rod ER from above as well as from underneath, to promote the solidification of the lapping glue and rail-like glue.

FIG. 7 also shows a garniture tape 66 removal mechanism 84.

The removal mechanism 84 includes a V-shaped link 86. The link 86 is rotatably supported at the base thereof and comprises a pair of link arms. At the end of one of the link arms, a tension roller 88 is rotatably mounted. The tension roller 88 guides the traveling of the garniture tape 66 and also imparts a specified tension to the garniture tape 66. The end of the other link arm is connected with the end of a piston rod of an air cylinder 90. When the air cylinder 90 is contracted from the state shown, the V-shaped link 86 rotates clockwise in FIG. 7, thereby moving the tension roller 88 upward. Consequently, the tension is removed from the garniture tape 66, so that the garniture tape 66 can be easily detached from the drive drum 68 and a large number of guide rollers.

After delivered from the wrapping apparatus 62, the composite element rod ER passes through a cutting apparatus 92. The cutting apparatus 92 cuts the composite element rod ER to a specified length, thereby forming individual filter rods FR.

More specifically, as shown in FIG. 6, the cutting apparatus 92 includes a cutting disk 94. The cutting disk 94 is able to rotate in one direction and disposed under the composite element rod ER forming path 64. The cutting disk 94 has a plurality of knives 96 on the circumferential surface thereof, where the knives 96 are arranged around the cutting disk 94 at equal intervals. As the composite element rod ER passes just above the cutting disk 94, the knives 96 of the cutting disk 94 periodically cuts the composite element rod ER, thereby forming individual filter rods FR from the composite element rod ER. The filer rods FR formed has a fixed length.

It is to be noted that as clear from FIG. 6, the cutting disk 94 of the cutting apparatus 92 is shared by the front and rear forming paths 64f, 64r so that the knives 96 of the cutting disk 94 cut the composite element rods ER traveled along the forming paths 64f, 64r respectively.

Additionally, the cutting apparatus 92 includes a pair of split sleeves 98. The split sleeves 98 are disposed on the front and rear forming paths 64f, 64r, at locations just above the cutting disk 94, respectively. The split sleeves 98 each guide the traveling of the corresponding composite element rod ER, and allow the knives 96 to pass across. Further, the front and rear forming paths 64f, 64r each include a transportation guide in the form of a groove (not shown). Each transportation guide extends from the cutting disk 94 to near the terminal end of the corresponding forming path. Each transportation guide guides the traveling of the filter rods FR delivered from the cutting apparatus 92, where the filter rods are in close contact with each other.

FIG. 8 specifically shows filter rods FR obtained from the filter element rod ER. It is to be noted that also in FIG. 8, the filter element rod ER and filter rod FR are shown with the covering of the paper web W omitted.

In FIG. 8, the filter rod FR in (I) has a filter element f_{C} located in the center, filter elements f_{A} before and behind the filter element f_{C}, and half-elements f_{CH} each adjacent to the end of a filter element f_{A}, where the half-elements f_{C} are each formed by cutting a filter element f_{C} in two halves. That is, the filter rod FR like this is obtained by cutting the composite element rod ER at the center of every second filter element f_{C}.

In order to obtain the filter rods FR like this, the circumferential speed of the cutting disk 94 of the cutting apparatus 92, or in other words, the timing at which the knives 96 perform cutting is determined on the basis of the traveling speed of the garniture tape 66 (circumferential speed of the drive drum 68) or the traveling speed of the composite element rod ER. Meanwhile, the timing at which the individual filter elements f_{A}, f_{C} are fed onto each conveyor 18 (circumferential speed of each feed wheel 50) is determined on the basis of the rotating speed of the cutting disk 94.

More specifically, the drive drum 68 and the cutting disk 94 are connected by a power transmission path (not shown), while the toothed pulley 56 (see FIG. 5) which determines the circumferential speed of the feed wheel 50 and the cutting disk 94 are connected by a power transmission path (not shown).

Each forming path 64 has a kicker roller 100 at the terminal end, where the kicker roller 100 is rotatably arranged just above the forming path 64. When a leading filter rod FR on the forming path 64 reaches the kicker roller 100, the kicker roller 100 accelerates and kicks out the leading filter rod FR, along the forming path 64, forward. In this way, filter rods FR are delivered from the terminal end of the forming path 64, at intervals.

Directly downstream of the front and rear forming paths 64f, 64r, a drum train 102 is arranged. The drum train 102 extends from the terminal ends of the forming paths 64f, 64r, horizontally and at right angles to the forming paths 64. In this embodiment, the drum train 102 comprises a receiving drum 104 located at the beginning end thereof, and an inspection/removal drum 105 and an output drum 106 which range from the receiving drum 104 in this order. The drums 104, 105, 106 each have a plurality grooves (not shown) in the circumferential surface thereof, where the grooves are arranged around the drum at equal intervals.

As the receiving drum 104 is rotated, two circumferentially adjacent receiving grooves meet the terminal ends of the forming paths 64, respectively, at the timing when the kicker rollers 100 kick out filter rods FR from the terminal ends of the front and rear forming paths 64f, 64r, respectively, so that the two receiving grooves of the drum 104 can receive the filter rods FR kicked out from the forming paths 64, respectively. In order to ensure that the receiving grooves receive the filter rods FR, the kicker rollers 100 kick out the filter rods FR in the direction deflected toward the direction of rotation of the receiving drum 104.

After this, the filter rods FR in the receiving grooves are transported in the direction of circumference of the receiving drum 104, then further transported by being received in receiving grooves in the inspection/removal drum 105 and in receiving grooves in the output drum 106, successively, and then delivered from the output drum 106. The filter rods FR delivered from the output drum 106 are received on a conveyor belt, and the conveyor belt transports the filter rods FR to a box packing machine.

As clear from the description above, the filter rods FR are transported in the manner that those kicked out from the front forming path 64f and those kicked out from the rear forming path 64r are arranged alternately on the drum train 102. Thus, when another output drum is added to the drum train 102 to be adjacent to the output drum 106, the filter rods FRf fed from the front forming path 64f and the filter rods FRr fed from the rear forming path 64r can be taken out separately by these output drums.

Above the inspection/removal drum 105, an inspection camera 108 is arranged. The inspection camera 108 images the filter rods FRf, FRr transported on the inspection/removal drum 105, and transmits the images of the filter rods FR to an inspection circuit 110 as image data Df, Dr.

The inspection circuit 110 determines whether or not the filter rods FRf, FRr are non-defective, on the basis of the image data Df, Dr, and sends control signals Sf, Sr to a phase change apparatus 112 on the basis of the inspection result. On the basis of the control signals Sf, Sr, the phase change apparatus 112 can change the feed phases of the composite element columns C_{Ef}, C_{Er} fed to the front and rear forming paths 64f, 64r, or in other words, the transportation phases of the filter elements f_{A}, f_{C} on the front and rear conveyors 18f, 18r. The details of the phase change apparatus 112 will be described later.

Next, the function of the inspection circuit 110 will be described specifically.

When the image data D transmitted from the inspection camera 108 to the inspection circuit 110 is obtained from a normal filter rod FR shown in (I) of FIG. 8, the half-elements f_{CH} at the opposite ends of the filter rod FR are each equal to half of the filter element f_{C}. In this case, the inspection circuit 110 determines that the filter rod FR in (I) of FIG. 8 is non-defective, and does not send out a control signal S.

The filter element f_{C} contains activated charcoal particle. Therefore, even though the filter rod FR is covered with the paper web W, the image of the filter rod FR shows different densities. Specifically, the part of the image indicating the filter element f_{C} is higher in density than the part of the image indicating the filter element f_{A}, so that in the image, a clear boundary is produced between the half-element f_{CH} and the filter element f_{A} due to the difference in density. Thus, the inspection circuit 110 can detect the length L of the half-element f_{CH} by measuring the distance from an end of the filter rod FR to such boundary.

Preferably, the above-mentioned end of the filter rod FR is the leading end of the filter rod FR transported along the formation path 64.

Since the timing at which the cutting apparatus 92 performs cutting is definitely determined on the basis of the traveling speed of the garniture tape 64 as already mentioned, when the length L of the half-element f_{CH} at the leading end of the filter rod FR is equal to half L_{O} of the length of the filter element f_{C}, also the length L of the half-element f_{CH} at the tail end of the filter rod FR is equal to the length L_{O}.

There are, however, cases in which the formation of the composite element rod ER by the wrapping apparatus 62 undergoes negative influence due to some reason, so that filter rods FR like those shown in (II) and (III) of FIG. 8 are formed. In the case (II), the length L of the half-element f_{CH} at the leading end of the filter rod FR is smaller than the length L_{O}, while the length L of the half-element f_{CH} at the tail end is greater than the length L_{O}. This means that a phase advance a is produced in the transportation of the composite element column E_{C}. In this case, the inspection circuit 110 determines that the filter rod FR is defective, and on the basis of the difference ΔL (=L_{O}−L) between the length L_{O} and the length L of the half-element f_{CH}, feeds a control signal S for advancing the transportation phase of the composite element column C_{E}, to the phase change apparatus 112. Meanwhile, in the case (III), the length L of the half-element f_{CH} at the leading end of the filter rod FR is greater than the length L_{O}, while the length L of the half-element f_{CH} at the tail end is smaller than the length L_{O}. This means that a phase delay d is produced in the transportation of the composite element column E_{C}. In this case, on the basis of the difference ΔL, the inspection circuit 110 feeds a control signal S for delaying the transportation phase of the composite element column C_{E}, to the phase change apparatus 112.

An example of the phase change apparatus 112 is shown in FIG. 9.

The phase change apparatus 112 is interposed in each power transmission path which connects the toothed pulley 56 of each element feeder 26a to 26d and the cutting disk 94 of the cutting apparatus 92. More specifically, the phase change apparatus 112 includes a triaxial differential gear mechanism 116. The differential gear mechanism 116 connects the toothed pulley 56 and an output gear 114 located at the terminal end of the power transmission path.

The differential gear mechanism 116 includes a gear casing 118, and the gear casing 118 has an input shaft 120 and an output shaft 122. The input shaft 120 and the output shaft 122 are aligned with each other, and each rotatably fitted to the gear casing 118 by means of a bearing 124. The output gear 114 is mounted on the input shaft 120, while the toothed pulley 56 is mounted on the output shaft 122.

The input shaft 120 and the output shaft 122 are connected by means of a Harmonic Drive (registered trademark) 126. The Harmonic Drive 126 comprises a wave generator 128, a flex spline 130 and a circular spline 131 arranged in this order from the center. The wave generator 128 is mounted on a correction shaft 132, and the correction shaft 132 is coaxially arranged within the input shaft 120, and has an end projecting beyond the input shaft 120.

An output shaft 136 of a step motor 134 is connected with this end of the correction shaft 132, where the step motor 134 is operated on the basis of the control signal S from the inspection circuit 110.

When the step motor 134 is stopped, the rotation of the input shaft 120 is transferred to the output shaft 122 via the Harmonic Drive 126, so that the output shaft 122 rotates in phase with the input shaft 120. Consequently, the feed wheel 50 rotated by the toothed pulley 56 on the output shaft 122 is rotated with the phase corresponding to the rotation phase of the input shaft 120 and feeds filter elements f onto the conveyor 18. In other words, the feed phase of the filter element f fed onto the conveyor has a fixed relationship with the timing of cutting the composite element rod ER, which is determined by the rotation phase of the input shaft 120.

When, however, a control signal S is fed from the inspection circuit 110 to the step motor 134, the step motor 134 rotates the correction shaft 132 in one direction according to the control signal S. This rotation of the correction shaft 132 operates the Harmonic Drive 126 to advance or delay the rotation phase of the feed wheel 50 (output shaft 122) relative to the timing of cutting the composite element rod ER (rotation phase of the input shaft 120). Therefore, the timing of feeding the filter element f_{A}, f_{C} from the feed wheel 50 onto the conveyor 18, or in other words, the transportation phase of the filter element f_{A}, f_{C} on the conveyor 18 changes.

Consequently, the feed phase of the composite element column C_{E} fed from the conveyor 18 onto the forming path 64, or in other words, the transportation phase of the composite element column C_{E} on the conveyor 18 is advanced or delayed, so that filter rods FR formed after this become non-defective ones as shown in (I) of FIG. 8.

It is to be noted that the above-described correction control on the transportation phase is carried out for each of the front and rear conveyors 18f, 18r, independently, where the rotation phases of the two feed wheels 50 associated with the same conveyor 18 are advanced or delayed together, on the basis of the same control signal S. It is also to be noted that defective filter rods FR as shown in (II) and (III) of FIG. 8 are removed from the inspection/removal drum 105.

Next, referring to FIG. 10, how the transportation phase of the composite element column C_{E} changes will be described.

Since the filter element f (f_{A}, f_{C}) fed onto the conveyor 18 by the feed claw 52 is sucked onto the suction belt 22, the initial speed V_{f1} of the filter element f agrees with the traveling speed V_{S} of the suction belt 22.

Since the traveling speed V_{G} of the garniture tape 66 is lower than the traveling speed V_{S} as mentioned above and the composite element column C_{E} extending from the front tongue 70 on the forming path 64 reaches the terminal end of the conveyor 18, the conveyor 18 travels in sliding contact with the composite element column C_{E}. Thus, when a filter element f newly fed onto the conveyor 18 butts against the tail end of the composite element column C_{E}, the traveling speed V_{f2} of the filter element f is reduced from the initial speed V_{f1} to the traveling speed of the composite element column C_{E}, i.e., the traveling speed V_{G} of the garniture tape 66.

Meanwhile, a pushing-out force F_{S} is exerted on the composite element column C_{E} on the conveyor 18 and a slight dragging force F_{G} is exerted on the composite element column C_{E} on the garniture tape 66 in the direction of traveling of the composite element column C_{E}, where the resultant force F_{F} on the composite element column C_{E} which pushes the composite element column C_{E} forward is represented by the expression
F_{F}=F_{S}+F_{G}.

The pushing-out force F_{S} is determined on the basis of a frictional force between the composite element column C_{E} and the suction belt 22 and a resistance which the ranging path exerts on the traveling composite element column C_{E}, while the dragging force F_{G} is determined on the basis of a friction between the composite element column C_{E} and the garniture tape 66.

In addition to the above-mentioned pushing-forward force F_{F}, a braking force F_{B} is also exerted on the composite element column C_{E}. The braking force F_{B} is determined on the basis of a resistance which the compressed air jetted from the air nozzle 80 exerts on the traveling composite element column C_{E} and a resistance which the front tongue 70 exerts on the traveling composite element column C_{E}.

When a filter element f of the composite element column C_{E} comes out of the front tongue 70 and reaches a position where the compressed air from the air blow nozzle 80 does not hit it, the filter element f no longer receives the braking force F_{B} and only receives the pushing-forward force F_{F}.

Thus, as shown in FIG. 10, just downstream of the front tongue 70, a slight space X is produced between the filter element f and the succeeding filter element f of the composite element column C_{E}. This space X is, however, removed when the composite element column C_{E} passes through the rear tongue 72, due to a resistance which the rear tongue 72 exerts on the traveling filter element f and a braking force which compressed air jetted from the air blow unit 82 exerts on the filter element f. Consequently, after passing through the rear tongue 72, the filter elements f of the composite element column C_{E} can be in close contact with each other.

When the pushing-forward force F_{F} is constant, the space X is kept constant. When, however, the pushing-forward force F_{F} is increased, the space X becomes greater, and when the pushing-forward force F_{F} is decreased, the space X becomes smaller.

Meanwhile, when the rotation phase of the feed wheel 50 is advanced, the pushing-forward force F_{F} tends to be increased, and when the rotation phase of the feed wheel 50 is delayed, the pushing-forward force F_{F} tends to be decreased. Such increase or decrease in the pushing-forward force F_{F} is thought to be caused by increase or decrease in the length of the composite element column C_{E} formed on the path between the feed wheel 50 and the front tongue 70, or in other words, increase or decrease in the frictional force between the composite element column C_{E} and the suction belt 22 when the rotation phase of the feed wheel 50 is changed.

Thus, by controlling the rotation phase of the feed wheel 50 on the basis of the control signal S as mentioned above, the space X can be varied. The variation in the space X advances or delays the transportation phase of the composite element column C_{E} between the rear tongue 72 and the short holder 74. Consequently, the cutting position on the composite element rod ER can be changed without changing the timing at which the cutting apparatus 92 performs cutting.

The present invention is not restricted to the above-described embodiment. Various modifications can be made to it.

For example, the phase change apparatus 112 can use various types of differential gear mechanisms and servo mechanisms in place of the Harmonic Drive 126.

The front and rear conveyor tracks 18f, 18r can each include a rotatable alignment drum at the terminal end, where the alignment drum has a plurality of spiral grooves in the circumferential surface thereof. The alignment drum receives a specified number of filter elements f in the spiral grooves from the corresponding conveyor 18, and the spiral grooves feed the filter elements f to the forming path 64, in close contact with each other, at intervals. In this case, the phase change apparatus 112 can change the transportation phase of the composite element column C_{E} on the forming path 64, by advancing or delaying the rotation phase of the alignment drum on the basis of a control signal S.

Further, the combination and the number of filter elements f constituting a filter rod FR are not restricted to those in the described embodiment but can be changed in various ways.

1. A filter rod making machine, comprising:
a hopper apparatus for feeding different types of filter elements, said hopper apparatus including a plurality of hoppers each storing a large number of departing rods for forming the filter elements, and a plurality of element feeders for taking the departing rods out of the hoppers, one by one, forming the filter elements by cutting the taken-out departing rods, and transporting the formed filter elements at intervals,
an element conveyor for receiving the filter elements from the element feeders of said hopper apparatus and transporting the received filter elements in one direction while continuously forming the filter elements into an element stream in which the different types of filter elements are arranged in the direction of transportation in a specified order,
a wrapping apparatus for receiving the element stream from the element conveyor, forming the received element stream into a composite element column in which the filter elements are in close contact with each other, forming the composite element column into a composite element rod by continuously wrapping the composite element column in a paper web, and delivering the formed composite element rod,
a cutting apparatus disposed downstream of said wrapping apparatus in the direction in which the composite element rod is delivered, for cutting the composite element rod into filter rods of a specified length, the filter rod including, at each end, a half-element produced from cutting the filter element of the same type in two halves,
an inspection apparatus for detecting the length of the half-element in the formed filter rod and feeding detection information, and
a change apparatus disposed on a filter element transportation path extending from each of the hoppers up to said wrapping apparatus, for changing a transportation phase of the composite element column on the basis of the detection information from said inspection apparatus.

2. The making machine according to claim 1, wherein
said wrapping apparatus includes
an endless garniture tape arranged to travel in the direction in which the element stream is transported and make the individual filter elements of the element stream travel with the paper web,
a tongue arranged to allow passage of the paper web and the element stream, form the composite element column by exerting a braking force on the individual filter elements of the element stream when the paper web and the element stream pass through the tongue, and allow the formed composite element column to be transported in the direction in which the garniture tape travels, and
braking means for further exerting a braking force on each of the filter elements forming the composite element column when the filter element is just leaving the tongue, thereby producing a specified space between the filter element that has left the tongue and the succeeding filter element, in the direction in which the composite element column is transported.

3. The making machine according to claim 2, wherein
said wrapping apparatus further includes a rear tongue disposed downstream of the front tongue in the direction in which the composite element column is transported and arranged to allow passage of the paper web and the composite element column, and
the rear tongue further exerts a braking force on the individual filter elements of the composite element column when the paper web and the composite element column pass through the rear tongue, thereby bringing the filter elements into close contact with each other so that the spaces between the individual filter elements are removed.

4. The making machine according to claim 2, wherein
the element feeder includes a feed wheel rotatably arranged near the element conveyor, and the feed wheel has, on a circumferential surface thereof, a plurality of feed claws arranged at equal intervals in a circumferential direction of the feed wheel so that the feed claws feed the individual filter elements onto the element conveyor at intervals.

5. The making machine according to claim 4, wherein
said change apparatus includes a differential gear mechanism capable of changing a rotation phase of the feed wheel, and a step motor for operating the differential gear mechanism on the basis of the detection information from said inspection apparatus.

6. The making machine according to claim 2, wherein
the element feeder includes a feed wheel arranged near the element conveyor rotatably, and the feed wheel has, on a circumferential surface thereof, a plurality of feed claws arranged at equal intervals in a circumferential direction of the feed wheel so that the feed claws feed the individual filter elements onto the element conveyor at intervals.

7. The making machine according to claim 6, wherein
said change apparatus includes a differential gear mechanism capable of changing a rotation phase of the feed wheel, and a step motor for operating the differential gear mechanism on the basis of the detection information from said inspection apparatus.

8. The making machine according to claim 2, wherein
the making machine further comprises a second element conveyor similar to the first element conveyor,
said wrapping apparatus forms composite element rods from the element streams fed by the element conveyors, respectively, and
said cutting apparatus is used in common for cutting both of the composite element rods sent out from said wrapping apparatus.

9. The making machine according to claim 8 wherein
the element feeder includes a feed wheel rotatably arranged near the element conveyor, and the feed wheel has, on a circumferential surface thereof, a plurality of feed claws arranged at equal intervals in circumferential direction of the feed wheel so that the feed claws feed the individual filter elements onto the element conveyor at intervals.

10. The making machine according to claim 9, wherein
said change apparatus includes a differential gear mechanism capable of changing a rotation phase of the feed wheel, and a step motor for operating the differential gear mechanism on the basis of the detection information from said inspection apparatus.

11. The making machine according to claim 9, wherein
the composite element column includes plain elements formed of a bundle of filter fiber wrapped in forming paper, and charcoal elements formed of a bundle of filter fiber containing activated charcoal particle wrapped in forming paper, and
said cutting apparatus cuts the composite element rod at the center of the charcoal element so that the filter rod has, at each end, a half-element produced from the charcoal element, where the half-element and the plain element are visually identifiable although covered with the paper web.

12. The making machine according to claim 11 wherein
the element feeder includes a feed wheel rotatably arranged near said element conveyor, and the feed wheel has, on a circumferential surface thereof, a plurality of feed claws arranged at equal intervals in circumferential direction of the feed wheel so that the feed claws feed the individual filter elements onto said element conveyor at intervals.

13. The making machine according to claim 12, wherein
said change apparatus includes a differential gear mechanism capable of changing a rotation phase of the feed wheel, and a step motor for operating the differential gear mechanism on the basis of the detection information from said inspection apparatus.

14. The making machine according to claim 11, wherein
said inspection apparatus includes a camera for imaging the filter rod, and an inspection circuit for detecting a length of the half-element included in the filter rod from an image of the filter rod fed from the camera, and the inspection circuit detects a boundary between the half-element and the plain element on the basis of a difference in density between the part of the image corresponding to the half-element and the part of the image corresponding to the plain element.
